(19) United States
(12) Patent Application Publication
(10) Pub. No.: US 2014/0215107 A1
(43) Pub. Date: Jul. 31, 2014

(54) Expander Bypass

(71) Applicant: Hewlett-Packard Development Company, L.P., (US)

(72) Inventors: Gururaj S. Morabad, Bangalore (IN); Guruprasad Ramachandrachar, Bangalore (IN); Narayana Rao Venkata Naga Sripada, Bangalore (IN)

(73) Assignee: HEWLETT-PACKARD DEVELOPMENT COMPANY, L.P., Houston, TX (US)

(21) Appl. No.: 13/753,489

(22) Filed: Jan. 29, 2013

(51) Int. Cl. G06F 13/00

(52) U.S. Cl. CPC G06F 13/00
USPC 710/100

(57) ABSTRACT

An expander including an IN port, an OUT port and expander logic circuitry. A bypass path is provided to bypass the expander logic circuitry when power to the expander is off.

### BACKGROUND

Storage devices may be housed together in a storage enclosure. The storage devices may for example be SAS (Serial Attached SCSI) or SATA (Serial ATA) disks. Plural storage enclosures may be grouped together in a cascade of storage enclosures by use of an expander.

### BRIEF DESCRIPTION OF THE DRAWINGS

Examples will now be described, by way of non-limiting examples only, with reference to the accompanying drawings, in which:

FIG. 1 shows an example of a storage system including a plurality of storage enclosures;

FIG. 2 shows an example of a bypass path for a storage enclosure;

FIG. 3 is a table showing an example of a DEMUX (demultiplexer) logical configuration; and

FIG. 4 shows an example of a storage enclosure having two expanders.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. The terms “a” and “an” are intended to denote at least one of a particular element. In addition, the term “a number of” is intended to mean one or more of a particular element.

Storage devices may be grouped together in a storage enclosure. A storage enclosure is sometimes referred to as JBOD (just a bunch or disks) and may house a number of storage devices, such as SAS disks, SATA disks, SSD etc. The storage devices may be individual storage devices or may be arranged in a RAID (Redundant Array of Independent Disks) etc.

A typical storage enclosure comprises an IN port, an OUT port, an expander and a plurality of storage devices. The expander is capable of receiving storage commands and routing them to the appropriate device in the storage enclosure, or to a device in another storage enclosure. Examples of storage commands include a read command, write command, information request, or an enclosure management command. An example of an expander is a SAS expander, which is a type of expander capable of handling both SAS and SATA devices.

A plurality of storage enclosures may be connected in a cascade. A cascade is an arrangement comprising a plurality of storage enclosures, including at least a first storage enclosure which is connected to a second storage enclosure downstream of the first storage enclosure.

The present disclosure proposes a bypass path such that, even if power to a storage enclosure is down, the storage enclosure may forward signals to another storage enclosure with which it is connected. This may enable a storage system comprising a plurality of connected storage enclosures to continue functioning, even if one of the storage enclosures has a power failure.

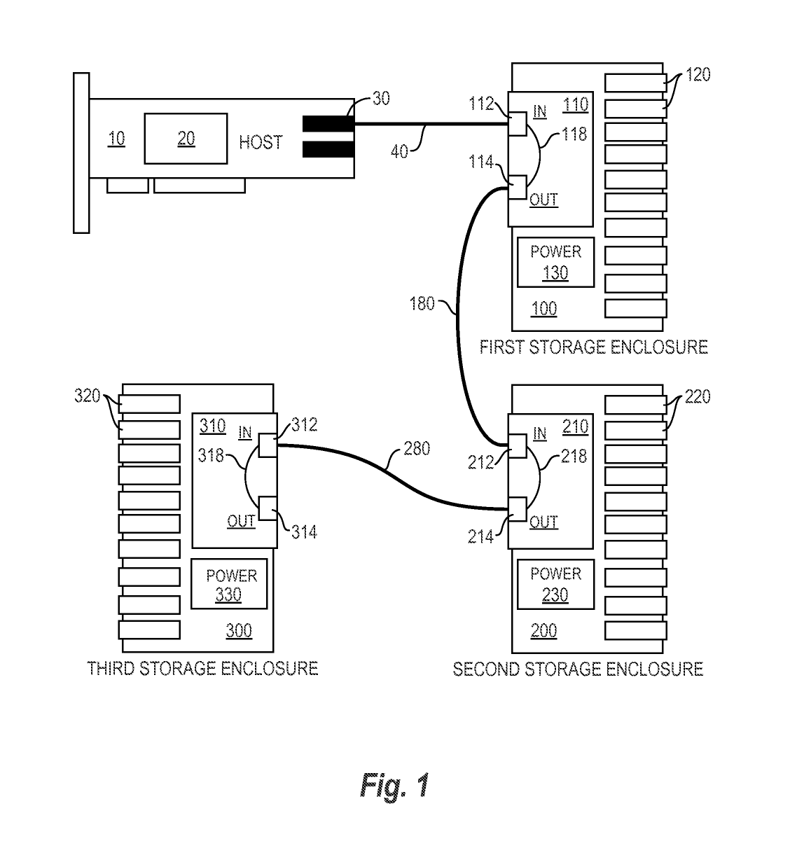

FIG. 1 shows an example of a storage system comprising an external host device 10, together with first, second and third storage enclosures 100, 200 and 300.

The host device 10 may for example be a host server, a storage controller such as an HBA (Host Bus Adapter), or a storage enclosure having storage control functionality. The host device has a processor 20 for generating commands and one or more ports 30 for communicating with the storage enclosures. Cables 40, 180, 280 may be used to physically connect the host device 10 with a storage enclosure or to connect respective storage enclosures with each other.

The storage enclosures are connected in a cascade, so the first storage enclosure 100 is connected to the second storage enclosure 200 which is connected to the third storage enclosure 300 in a daisy-chain. The host device 10 can thus send a command to the second storage enclosure 300 via the first storage enclosure 100, or to the third storage enclosure 300 via the first 100 and second 200 storage enclosures.

The first storage enclosure 100 has an IN port 112, an OUT port 114, an expander 110 and a plurality of storage devices 120 attached to the expander. The expander 110 typically takes the form of a circuit board (an ‘expander board’). The expander 110 includes ‘expander’ logic circuitry to route received signals (such as commands) to one of the storage devices 120 attached to the expander, or to route the signals to another storage enclosure. The routing is typically on the basis of a destination address, so a command addressed to a device 120 attached to the expander 110 is routed to that device and a command addressed to a device belonging to another storage enclosure is routed to that storage enclosure. For example, in the case of a SAS system the commands are addressed to a particular port by a port identifier.

The storage enclosure also has a power source 130 for supplying power to the expander. In most cases the same power source 130 will also supply the storage devices 120 and any other peripheral devices housed by the storage enclosure. The expander logic circuitry 111 may not be able to function correctly, or even at all, if no power is supplied to the expander.

The storage enclosure may have a management device for managing functions of the enclosure such as power, fan speed etc. The management device may be integral with the expander board or provided as a separate device.

The expander's IN port 112 and OUT port 114 are external ports for communication between the storage enclosure and external devices. They may be capable of bi-directional communication, e.g. the IN port 112 may receive commands from the host device 10 and transmit replies to the host device 10, while the OUT port 114 may relay commands to the second storage enclosure in the cascade and receive replies transmitted or relayed by the second storage enclosure.

The expander 110 may also have one or more internal ports for communication with devices 120 within the storage enclosure. For example, it may have one or more ports to communicate with ‘peripheral’ storage devices 120 attached to the expander and may have an enclosure management port to communicate with an enclosure management device (this may be a virtual port if the management device is integral with the expander or a real port if the management device is external to the expander). For instance a SAS expander has a SES (SCSI Enclosure Services) protocol target port for communication with an enclosure management module and one or more peripheral device target ports for communication with peripheral storage devices.

It should be noted that while all the storage enclosures shown in FIG. 1 include peripheral storage devices 120, it is possible to have a storage enclosure which does not house any storage devices (e.g. it acts only as an expander to connect to other storage enclosures, or may have unused slots to receive storage devices in case further expansion is needed).

The storage enclosure 100 has a bypass path 118 to bypass the expander logic circuitry in the event of a power failure. The bypass path 118 may be integral with the expander 110, or may be separate therefrom.

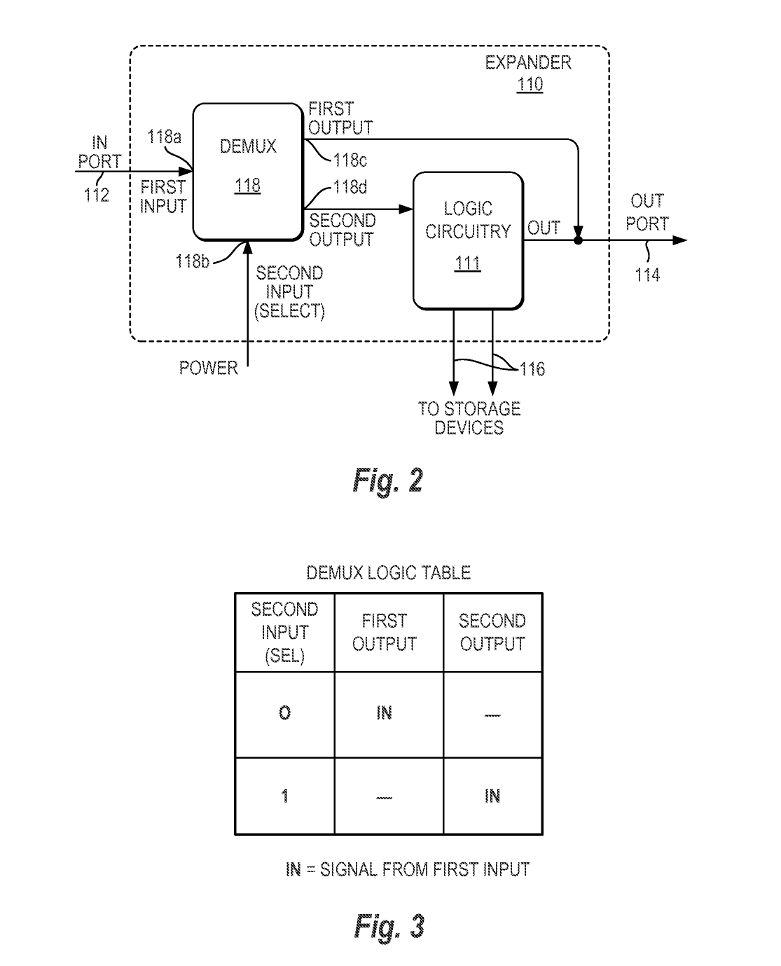

FIG. 2 shows an example expander board 110 in which a DEMUX (demultiplexer) acts as the bypass path 118. The DEMUX has a first input 118a, a second input (also known as a ‘select line’ or ‘select input’) 118b, a first output 118c and a second output 118d. The first input 118a of the DEMUX is connected to the IN port 112 of the storage enclosure 110. The second ‘select’ input 118b of the DEMUX is connected to the expander's power source 130. The DEMUX's first output 118c is connected to the OUT port 114 of the expander and the second output 118d is connected to the expander logic circuitry 111.

The DEMUX is configured so that it routes traffic received on the IN port 112 to the expander logic circuitry 111 under normal circumstances, but routes the traffic directly to the OUT port 114 if power is down. Put another way, the DEMUX is configured to act as a short circuit between the IN port 112 and the OUT port 114 to bypass the expander logic circuitry if there is a power failure.

From the DEMUX's point of view, it receives storage signals (e.g. SAS protocol communications) on its first input 118a and directs these storage signals to its second output 118d (which is connected to the expander logic circuitry 111), if a signal indicating power on is received on its second ‘select’ input 118b. However, if a signal indicating power off (or no signal) is received on its second (‘select’) input 118b, then the DEMUX directs the storage signals to its first output 118c (the expander logic circuitry bypass).

In FIG. 2, the DEMUX 118, IN port 112 and OUT port 114 are integral with the expander 110. However, it would be possible to have the DEMUX, IN port and/or OUT port provided separately (e.g. on one or more separate boards). For example, the IN port, OUT and DEMUX may be provided on a separate board, or in a housing or chassis of the storage enclosure rather than on the expander board. However, the connections of the IN port 112 and the OUT port 114 to the DEMUX circuitry 118 and the expander logic circuitry 111 would still be the same as shown in FIG. 2.

FIG. 3 shows a table with an example of one possible logic configuration for the DEMUX. The tables shows that the routing of signals received on the DEMUX's first input (the ‘IN line’) 118a depends upon the state of the select signal received on the second input (the ‘select line’) 118b. If the select signal 118b is low (0 indicating no power or power failure) then the signal received on the IN line 118a is directed to the first output 118c and no signal is provided to the second output. However, if the select signal 118b is high (1) then the signal received on the IN line 118a is directed to the second output 118d and no signal is provided to the first output. As the DEMUX routes signals to the first output by default if no power is supplied, it may be able to direct signals appropriately even when the storage enclosure has a power failure.

In the example shown in FIG. 1 all of the storage enclosures have a bypass path. While it is possible for some of the storage enclosures not to have a bypass path, that would mean that enclosures without a bypass path may not be able to forward signals in the event of power failure and may cause a break in the daisy chain.

By using a bypass 118, downstream storage enclosures may still be reachable, even if the enclosure having the bypass 118 is down. For instance, if the second storage enclosure 200 has a power failure, then in the example of FIG. 1, the third storage enclosure 300 will be cut off from the host device.

Thus, storage devices in enclosures downstream of a storage enclosure having a power failure may still be reached. In cases where a RAID group is split between plural storage enclosures, the location of the member RAID drives may be selected such that data can be recovered even if one storage enclosure has a power failure. For instance, if for each RAID group, there is at most one drive in each storage enclosure, then in the event that one storage enclosure has a power failure; it should be possible to reconstruct the data from other drives in the RAID. For example, a RAID 5 configuration usually requires at least three drives to form the RAID group and could have one drive in each enclosure of FIG. 1.

For instance, in FIG. 1 a RAID group may include a first drive in the first storage enclosure, a second drive in the second storage enclosure and a third drive in the third storage enclosure. Parity will be distributed in all the drives and if any drive fails (or becomes inaccessible due to a failure of the storage enclosure in which it is housed), then the data on that drive can be retrieved or calculated from the data and parity information on the remaining drives in the RAID group. Thus, if the second storage enclosure has a power failure, it should be possible to reconstruct or derive the data on the second drive from the first and third drives. Even though the storage enclosures are cascaded, in the event of power failure in the second storage enclosure, it is still possible to communicate with the third drive by virtue of the bypass in the second storage enclosure.

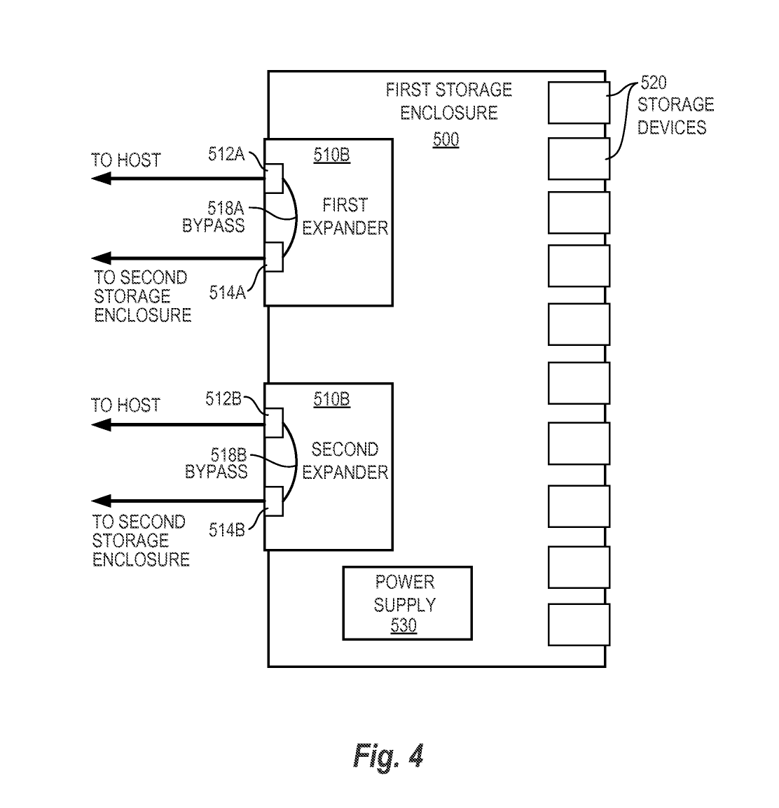

FIG. 4, shows an example which provides further redundancy by use of a second (backup) expander. The storage enclosure 500 has a power supply 530 and a plurality of storage devices 520. However it also has both first 510A and second 510B expanders, as well as first and second IN ports and first and second OUT ports. The first IN port 512A is associated with the first expander 510A and is connected to a first port of the host device or a first expander of an upstream storage enclosure. Meanwhile, the second IN port 512B is associated with the second expander 510B and is connected to a second port of the host device or a second expander of an upstream storage enclosure. Meanwhile, the first OUT port 514A is associated with the second expander 510A and may be connected to a first expander of a downstream storage enclosure while the second OUT port 514B is associated with the second expander 510B and may be connected to a second expander of a downstream storage enclosure.

Both the first and second expanders 510A, 510B are powered by the same power supply 530 and connected to the storage devices 520. The presence of first and second expanders 510A, 510B in this example provides ‘connection redundancy’ in that protects against a failed communication link (e.g. if a cable is faulty, a connection accidentally unplugged, or a port on the host device is down), but does not protect against power failure of an enclosure. However, protection against power failure of the storage enclosure is provided by a backup path for at least one of the first and second expanders. In one example, each expander is provided with a respective backup path 518A, 518B, for example by integrating a DEMUX into each expander board as shown in FIG. 3.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A storage enclosure comprising:
an IN port and an OUT port;
an expander including expander logic circuitry to route signals received at the IN port to either a destination within the storage enclosure or to the OUT port; and
a bypass path to direct signals received at the IN port to the OUT port in the event of power failure.

2. The storage enclosure of claim 1 wherein the storage enclosure houses a number of storage devices.

3. The storage enclosure of claim 1 wherein the bypass path is integrated into the expander.

4. The storage enclosure of claim 1 wherein the bypass path is separate from the expander.

5. The storage enclosure of claim 1 wherein the bypass path includes a demultiplexer (DEMUX) circuit.

6. The storage device of claim 5 wherein the DEMUX circuit has a first input connected to the IN port, a second input connected to a power source, a first output connected to an input of the expander logic circuitry and a second output connected to the OUT port.

7. The storage device of claim 5 wherein the DEMUX circuit is to direct signals received at the IN port to the expander logic circuitry when power is received on a select input of the DEMUX circuit and to the OUT port when power is not received on the select input of the DEMUX circuit.

8. The storage device of claim 1 further including a second IN port, a second OUT port and a backup expander to route signals received at the second IN port to a device housed by the storage enclosure or to the second OUT port, and a second bypass path to direct signals received at the second IN port to the second OUT port in the event of power failure.

9. A storage system comprising a plurality of storage enclosures including a first storage enclosure and a second storage enclosure;
wherein the first storage comprises:—
an IN port to receive commands from an external host device;
an OUT port connected to a port of the second storage enclosure;
expander logic circuitry to direct commands received at the IN port to a device of the first storage enclosure, if the command is addressed to a device of the first storage enclosure, or to direct commands to the OUT port if the command is addressed to a device of another storage enclosure; and
a bypass path to direct all commands received at the IN port to the OUT port, if power to the first storage enclosure is down, thereby bypassing the expander logic circuitry of the first storage enclosure and directing the commands to the second storage enclosure when power to the first storage enclosure is down.

10. An expander for use in a storage enclosure, the expander comprising:
an IN port;
an OUT port;
expander logic circuitry to route storage commands received at the IN port; and
a bypass path to bypass the expander logic circuitry when power to the expander is off so that, when power to the expander is off, signals received at the input port are routed to the OUT port.

11. The expander of claim 10, wherein the bypass path includes a DEMUX having a first input, a second input, a first output and a second output; and wherein the first input is connected to the IN port of the expander, the first output is connected to the OUT port of the expander, the second output is connected to the expander logic circuitry, and the second input is for connection to a power source which is to supply power to the expander.

12. The expander of claim 10 wherein the bypass path includes a DEMUX that is to provide a short circuit between the input and output ports of the expander when no power is supplied to the expander.

13. The expander of claim 10 wherein the expander includes a storage enclosure management port.

14. The expander of claim 10 wherein the expander includes a peripheral device port.

15. The expander of claim 10 wherein the expander is a SAS expander.
